(19) United States
(12) Patent Application Publication
(10) Pub. No.: US 2018/0095006 A1
(43) Pub. Date: Apr. 5, 2018

(54) METHOD FOR NON-DESTRUCTIVE MATERIAL TESTING

(71) Applicant: Siemens Aktiengesellschaft, Munchen (DE)

(72) Inventors: MICHAEL CLOSSEN-VON LANKEN SCHULZ, ISSUM (DE); STEFAN OBERMAYR, DUISBURG (DE); ALBERT SCHREY, KERKEN (DE)

(21) Appl. No.: 15/718,039

(22) Filed: Sep. 28, 2017

(30) Foreign Application Priority Data
Oct. 4, 2016 (DE) 10 2016 219 171.3

(51) Int. Cl. G01M 15/14

(52) U.S. Cl. CPC G01M 15/14

(57) ABSTRACT

Provided is a method for the non-destructive material testing of a component that defines a receptacle groove for the blade root of a blade of an axial turbomachine, the component in particular being a shaft of a turbine or of a compressor, or of a rotor disk that is provided on the shaft, and of a blade root of a blade, wherein the testing head of a testing apparatus for non-destructive material testing in the assembled state is disposed in an intermediate space formed in the region of the receptacle groove between the component that defines the receptacle groove and the blade root, and in particular is displaced in the intermediate space, and the component that defines the receptacle groove and/or the blade root by way of the testing head that is disposed in the intermediate space are/is examined in a non-destructive manner for material faults.

### CROSS-REFERENCE TO RELATED APPLICATIONS

This application claims priority to German application No. 10 2016 219171.3 having a filing date of Oct. 4, 2016, the entire contents of which are hereby incorporated by reference.

### FIELD OF TECHNOLOGY

The following relates to a method for the non-destructive material testing of a component that defines a receptacle groove for the blade root of a blade of an axial turbomachine, said component in particular being a shaft of a turbine, or of a compressor, or of a rotor disk that is provided on the shaft, and of a blade root of a blade.

### BACKGROUND

It is known for receptacle grooves to be provided for fastening the blades in axial turbomachines such as turbines or compressors, the contour of said receptacle grooves being adapted to the contour of the blade roots of the blades. The receptacle grooves which are also referred to as “rotor steeples” are provided at equidistant spacing along the circumference of a shaft or of a rotor disk of the rotor of the turbomachine that is fastened to the shaft, for example, and in the axial direction of the turbomachine extend through the shaft or the rotor disk, respectively. The contour of the receptacle grooves corresponds to the contour of the blade roots of the blades to be fastened, wherein the specific shape is typically chosen in such a manner that the blade roots can be push-assembled into the receptacle grooves in the axial direction, in the assembled state sit in a form-fitting manner in the respective receptacle groove, and in the radial direction of the turbomachine are securely held so as not to be released as the rotor rotates. A well-known contour of the receptacle grooves and of the corresponding blade roots that is widely used is the so-called “pine tree contour”, for example.

Turbine blades having blade roots of inter alia a pine-tree shaped contour are derived from EP 2 282 010 A1, for example. In the operation of the turbomachine, the blades are subjected to high mechanical stress. For example, final-stage blades of steam turbines are among the most highly stressed components in a turbine. By virtue of the high stress, fatigue and damage to the material can arise in the region of the blade fastening, above all in the region of the receptacle grooves, both in terms of the components that define the receptacle grooves as well as in terms of the blade roots that are received in said receptacle grooves. Operation-related cracks thus are occasionally created on the components comprising the receptacle grooves, for example.

### SUMMARY

An aspect relates to a method for non-destructive material testing of the type mentioned at the outset which can be carried out in a simple, rapid, and cost-effective manner.

This aspect in a method of the type mentioned at the outset is achieved in that the testing head of a testing apparatus for non-destructive material testing in the assembled state is disposed in an intermediate space formed in the region of the receptacle groove between the component that defines the receptacle groove and the blade root, and in particular is displaced in the intermediate space, and the component that defines the receptacle groove and/or the blade root by way of the testing head that is disposed in the intermediate space are/is examined in a non-destructive manner for material faults.

In other words, embodiments of the invention are based on the concept of utilizing an intermediate state that in the assembled state exists in the region of the receptacle groove, in order to introduce thereinto a testing head for the non-destructive material testing of the component that defines the receptacle groove and/or of a blade root that is disposed in the receptacle groove. It becomes possible in this way for non-destructive material testing to be carried out in the assembled state, that is to say when the blade root for fastening the blade has been inserted into the receptacle groove. Since the examination for material wear, in particular for the existence of cracks in the fastening region of the blades is possible without the blades having to be removed, the method according to embodiments of the invention can be carried out in a simple and rapid manner. In particular, the downtime of an axial turbomachine which is associated with a check-up can be optimized by using the method according to embodiments of the invention.

Measured values for the non-destructive material test are acquired by the testing head of the testing apparatus while the testing head is disposed in the intermediate space, or is displaced in the latter, respectively. In principle, any suitable testing apparatus can be used for the non-destructive test. In an exemplary manner, testing apparatus for eddy current testing and ultrasonic testing, which comprise at least one eddy current or ultrasonic testing head, respectively, which according to embodiments of the invention is introduced into an intermediate space in the region of the receptacle groove, are to be mentioned.

The use of an eddy current testing apparatus having an eddy current testing head can be particularly expedient for the non-destructive testing of the component that defines the receptacle groove for surface cracks for example, while the use of a testing apparatus having an ultrasonic testing head can be particularly expedient for non-destructive testing of a blade root that sits in a receptacle groove and can at least be partially covered by ultrasound when the ultrasonic testing head is disposed according to embodiments of the invention in an intermediate space.

According to embodiments of the invention, the testing head of the testing apparatus is in particular displaced in the intermediate space, that is to say that a dynamic measurement is carried out by a moving testing head, by way of which dynamic measurement a comparatively large region of the component to be tested can be examined for faults, in particular cracks.

The testing head is preferably disposed and in particular displaced in an intermediate space which is distinguished by a consistent cross section in the axial direction of the axial turbomachine. Furthermore, the testing head in one preferred design embodiment is displaced at least once in the intermediate space across the entire axial extent of the latter.

The intermediate space which according to embodiments of the invention is utilized in order for a testing head for the non-destructive material testing in the assembled state to be disposed in the region of the receptacle groove can be such an intermediate space which from the outset has been provided in a targeted manner for this purpose. Said intermediate space can thus be an intermediate space that in a precautionary manner has been incorporated as a “testing gap” at a suitable location. This can be taken into account already in the conception of the components, such that the receptacle grooves and/or the blade roots can be manufactured in a targeted manner with a shape in which intermediate spaces of this type that serve as “testing gaps” are provided at suitable locations in the assembled state, for example.

Alternatively, an intermediate space which already exists for another reason can also be utilized. One particularly advantageous embodiment of the method according to embodiments of the invention is thus distinguished in that the testing head is disposed and in particular displaced in an intermediate space which has been obtained by mechanical post-machining of the component that defines the receptacle groove and/or of the blade root, in particular in that material faults which have preferably been detected in a preceding non-destructive material test are removed, preferably milled and/or ground, from the component that defines the receptacle groove or from the blade root.

For example, once a component such as a shaft or a rotor disk that defines a receptacle groove, and blades that are fastened thereto, have been in operation for the first time, said component and blades in the disassembled state can first be tested in a non-destructive manner for the presence of faults, in particular surface cracks. To this end, the surface of the component having a receptacle groove or grooves is tested in a non-destructive manner by means of a testing head of a suitable testing apparatus in the region of the receptacle groove(s) and/or the surface of the blade roots is tested in a non-destructive manner when the blades have been removed.

Cracks which have potentially arisen during the operating period are detected herein. Apart from the position of the cracks and from the length of the latter, there is also the possibility for crack depths to be indirectly determined. For example, determining the crack depths is performed most precisely in that random samples of the indicators are mechanically machined, for example milled, and then subjected to further crack testing until no more indicators are left. Indicators herein are to be understood as measuring signals which have been acquired in the context of a suitable testing method employed and exceed a predefined value. In the case of visual tests, said indicators correspond to irregularities such as cracks on the surface, for example. If eddy current testing is carried out, said indicators are amplitudes, for example, the height or phase of said amplitudes deviating in relation to those amplitudes that have been acquired in the undamaged regions. In the context of ultrasonic testing, said indicators can be amplitudes, for example, or the absence of the latter in terms of running time and angle.

When faults such as surface cracks are detected, the faulty material regions can be removed by mechanical post-machining in order for the respective component to be restored to an operationally ready state. The removal of the damaged regions can be performed by milling or grinding, for example. An assessment in terms of residual service life can also be performed while taking into account usual crack growth rates depending on materials, temperatures, mechanical stress, and existing geometries.

In the region of the mechanical post-machining for the removal of faults, which depending on the damage can be performed in the component having the receptacle groove, in the blade root, or in both, there is then in the region of the receptacle groove a deviation between the shape of the blade root and of the component that defines the receptacle groove. Once a blade root has been reinserted into the associated receptacle groove, an intermediate space or a “gap”, respectively, is created where post-machining has taken place. If material is removed from a plurality of locations, there can of course also be a plurality of intermediate spaces or “gaps”, respectively, in the assembled state.

According to this embodiment, such a gap that is obtained by the fault-removing post-machining is utilized in a targeted manner for a testing head to be disposed therein according to embodiments of the invention. This embodiment thus makes it possible in particular for components having one receptacle groove or a plurality of receptacle grooves, or blade roots disposed therein, respectively, which have already been mechanically post-machined to be subjected again to a non-destructive material test without major complexity, wherein the region of post-machining, that is to say the post-machined contour, can be examined in particular.

In order for the faulty regions, in particular those having cracks, to be milled, preferably a removal of material across the entire axial extent of the component having the receptacle groove, or of the blade root, respectively, that is to say from the entry point of the steam up to the exit point of the steam, can have been performed by way of a defined cutting shape. The intermediate space is then defined by an elongate post-machining groove which results from said milling and which in the axial direction is distinguished by a consistent cross section and has two open end sides.

Since the method according to embodiments of the invention is carried out in the assembled state and is thus associated with minor complexity, particularly efficient and reliable monitoring of the state of components of axial turbomachines can be performed. Better planning and an optimized maintenance concept can also be achieved; in particular, repairs, the replacement of components, and order and delivery times can be optimized.

By way of the method according to embodiments of the invention it moreover also becomes possible for monitoring performed permanently, in particular also during the operation of the axial turbomachine, to be implemented. To this end it is then provided that the testing head that is disposed in the intermediate space remains in the intermediate space for a predefined temporal period which in particular includes an operating period of the axial turbomachine, and in particular the component that defines the receptacle groove and/or the blade root by way of the testing head that is disposed in the intermediate space are/is examined in a non-destructive manner for material faults during the operation of the axial turbomachine.

If the testing head according to the embodiment is introduced into the intermediate space and remains therein, in particular also during the operation, damage, in particular cracks, can be detected online, and it is possible to react thereto without delay. A permanent instrumentation of this type is particularly interesting, for example when faults such as surface cracks have already been detected during a preceding check-up of a component, but said surface cracks were not able to be completely removed. This arises, for example, when cracks of which the crack depth has exceeded the maximum dimension permissible for post-machining are present. If respective locations are provided with permanent instrumentation, a crack growth can be identified online, in the case of an eddy current probe in the form of a variation in an amplitude or phase, for example.

In order for the measured values that have been acquired by the testing head disposed permanently in the intermediate space to be transmitted in an expedient design embodiment to an acquisition and evaluation unit that is disposed outside the intermediate space, the testing head can be equipped with means for wireless transmission, for example, or a cable connection is provided.

In particular, renewed non-destructive testing of a groove that exists by virtue of a preceding removal of faults can be performed according to embodiments of the invention with minor complexity. This represents a great advantage since the probability of damage, in particular cracks, arising again is typically particularly high in particular where mechanical post-machining, in particular for the removal of cracks, has already been performed.

A residual service life that has optionally already been calculated can be dynamically adjusted and even prolonged by periodic testing. For example, if it is estimated for a mechanically post-machined location and assumed that it is highly probable that new cracks appear, it can be checked in a simple manner by way of the method according to embodiments of the invention whether this is a matter of fact. Should it become apparent after said method has been carried out that no damage has yet arisen at a point in time expected, a longer residual service life can obviously be set.

Depending on the overall constellation, repeated testing of the low-pressure final stage blades can also be performed from the condenser, without the turbine being opened, for example. If a post-machined groove is located in a component such as a rotor disk having a receptacle groove that is located in the last sequential stage of a low-pressure turbine, the steam exit side, in particular one of the end sides of the component having the receptacle groove, is accessible directly by way of the condenser. Access can be established by way of a manhole, for example, usually by way of a scaffold that is disposed in the condenser.

Of course, it is possible for more than one testing head to be disposed in the intermediate space and in particular to be displaced therein. Also, in the case of a plurality of intermediate spaces being available, a plurality, in particular all, of the available intermediate spaces can be utilized in the manner according to embodiments of the invention, so as to incorporate in each case one or else a plurality of testing heads in said intermediate spaces and in particular to displace said testing heads in the latter. On account thereof, a comparatively large region of the component having the receptacle groove and/or of the blade root can be covered in the assembled state by non-destructive material testing according to embodiments of the invention.

According to one particularly expedient embodiment, a testing head of which the cross section is adapted to the cross section of the intermediate space is used. In particular, the testing head can then sit in a form-fitting manner in the intermediate space, such that the former is held at a predefined orientation within the intermediate space, on account of which particularly reliable measured results are obtained. Also, a testing head according to this embodiment, for example when said testing head is displaced in the axial direction in an intermediate spacing having a consistent cross section in the axial direction, is oriented in a uniform manner during the entire dynamic measurement such that comparable measured results can be obtained across the entire axial extent of the intermediate space.

In particular, the testing head or testing heads, respectively, that is/are used in the context of the method according to embodiments of the invention, can be specially made. For example, a testing head, in particular an eddy current or ultrasonic testing head, of which the cross section corresponds to that of the intermediate space is manufactured for an arrangement having one intermediate space or a plurality of intermediate spaces of given cross section. For example, the testing head herein can have a main body of which the shape is adapted to that of the intermediate space, and a testing element, or a plurality of testing elements, such as coils in the case of the eddy current testing head, can be disposed in the main body.

It is also possible that a plurality of non-destructive testing methods in combination are employed in the context of the method according to embodiments of the invention. For example, to this end a testing head which has testing elements for more than one non-destructive material testing method can be resorted to. Also, a plurality of testing heads that are designed for dissimilar testing methods can be disposed and in particular displaced simultaneously or sequentially in the intermediate space. For example, one eddy current testing head and one ultrasonic testing head can be disposed and in particular displaced in the intermediate space, specifically in a simultaneous or sequential manner.

An intermediate space that has been created by virtue of mechanical post-machining for the removal of cracks typically has a diameter of a magnitude of a few millimeters, for example of up to 3 millimeters, such that in this case a testing head having a corresponding diameter of likewise only a few millimeters, for example up to 3 millimeters, is expediently employed in this case.

One further embodiment of the method according to embodiments of the invention is distinguished in that the testing head is disposed and in particular displaced in an intermediate space which at least largely is formed by a clearance that is provided in the component that defines the receptacle groove. The clearance in the component having the receptacle groove can in particular be a clearance such as has been obtained by removing material that has been damaged in an operation-related manner from the component, preferably a post-machined groove that has been obtained for example by milling.

A clearance in the component that defines the receptacle groove is open in particular on that side on which the original contour of the receptacle groove ran prior to post-machining of the component, and this open side of the clearance in the assembled state is closed by a blade root that sits in the receptacle groove. The intermediate space is then defined by the clearance and by the blade root that in the assembled state closes said clearance on one side.

Alternatively thereto, the testing head can also be disposed and in particular displaced in an intermediate space which is at least largely formed by a clearance that is provided in the blade root, or else the intermediate space is defined by a clearance that lies both within the blade root as well as within the component having the receptacle groove, that is to say said intermediate space is established by clearances in both components that in the assembled state are mutually contiguous.

It can furthermore be provided that the testing head is disposed and in particular displaced in an intermediate space which extends across the entire extent of the receptacle groove and/or of the blade root in the axial direction of the axial turbomachine. Furthermore preferably, the intermediate space is accessible from one end side or both end sides of the component that defines the receptacle groove, and/or of the blade root.

In particular with a view to the case that mechanical post-machining of the component having the receptacle groove and/or of the blade root has been necessary by virtue of a preceding detection of faults, the intermediate space can be formed by a post-machined groove that extends in the axial direction in the component having the receptacle groove, or in the blade root, or in both, said post-machined groove extending across the entire axial extent of the receptacle groove and of the blade root, that is to say from the steam entry to the steam exit. The intermediate space that is defined by such a post-machined contour in the assembled state, that is to say when the blade root is inserted, in particular push-fitted, into the receptacle groove, is open toward both ends and can be used in a particularly comfortable manner for carrying out the method according to embodiments of the invention.

It can be furthermore provided that the testing head is disposed in an elongate intermediate space and in particular is displaced in the longitudinal direction in the latter, wherein the elongate intermediate space preferably extends in the axial direction of the axial turbomachine.

In particular, the intermediate space can be formed by a post-machined groove that extends across the entire axial extent of the receptacle groove, or of the blade root, respectively, and has a consistent cross section in the axial direction. Such a post-machined groove can have been obtained, for example, in that a milling tool having a matching contour has been driven through from the one to the other end side of the component, the latter being the blade root, or of the component that defines the receptacle groove, respectively, in particular in order for crack-containing material to be removed.

In a refinement of the method according to embodiments of the invention, the testing head is disposed and in particular displaced in an intermediate space which has a curvature. The curvature herein can correspond to a curvature of the receptacle groove. For example, the blade root can have a pine-tree shaped contour, the channels and protrusions of said blade root having a curved profile. The intermediate space can then be defined by a post-machined groove, for example, which has a curvature which follows that of the channels and protrusions of the pine tree contour.

In an advantageous refinement a testing head which is connected to a guide element can be used. The guide element can be a guide bar. This design embodiment enables in particular that the testing head is introduced in a comfortable manner into the intermediate space from an open end side of the latter and in particular is moved in the axial direction through said intermediate space, in order for a dynamic measurement for non-destructive material testing to be carried out. The testing head by means of the guide element can be displaced uniformly in the intermediate space, in order for particularly reliable measured results to be obtained.

If the intermediate space is distinguished by a curvature, a guide element, in particular a guide bar, which is likewise curved is preferably employed. The curvature of the guide element in an expedient design embodiment is then adapted to the curvature of the intermediate space.

It is also possible for a plurality of testing heads to be disposed in the intermediate space and in particular to be displaced therein. In this case, it can be provided in particular that the plurality of testing heads are disposed on a guide element, in particular a guide bar.

If dynamic measuring is performed, it can be furthermore provided in an expedient design embodiment that at least one position encoder is used in order for an in particular axial position coordinate to be able to be assigned to the measured values in the case of a moving testing head. A steel cable encoder can be employed as a position encoder, for example, wherein the free end of the steel cable then is fastened in particular to the testing head. Of course, other position encoders which operate optically, for example, such as with laser light, can likewise be used.

If a position encoder is resorted to, in particular position-dependent set of measured values, can be stored. The stored data by way of an analytical method can be evaluated in a positionally correct manner directly upon measuring, for example. Image-providing methods (C-scan illustrations, for example) herein particularly benefit from a positionally correct representation of the measured data. Being diagnostic findings, the measured data stored that pertains in particular to detected cracks and includes the associated axial position can be resorted to for further subsequent mechanical measures, in particular for a mechanical removal of cracks. Alternatively to displacing the testing head, a dynamic measurement can also be “simulated” when a testing head having a plurality of testing elements which are electronically activated in a sequential manner is employed.

### BRIEF DESCRIPTION

Some of the embodiments will be described in detail, with reference to the following figures, wherein like designations denote like members, wherein:

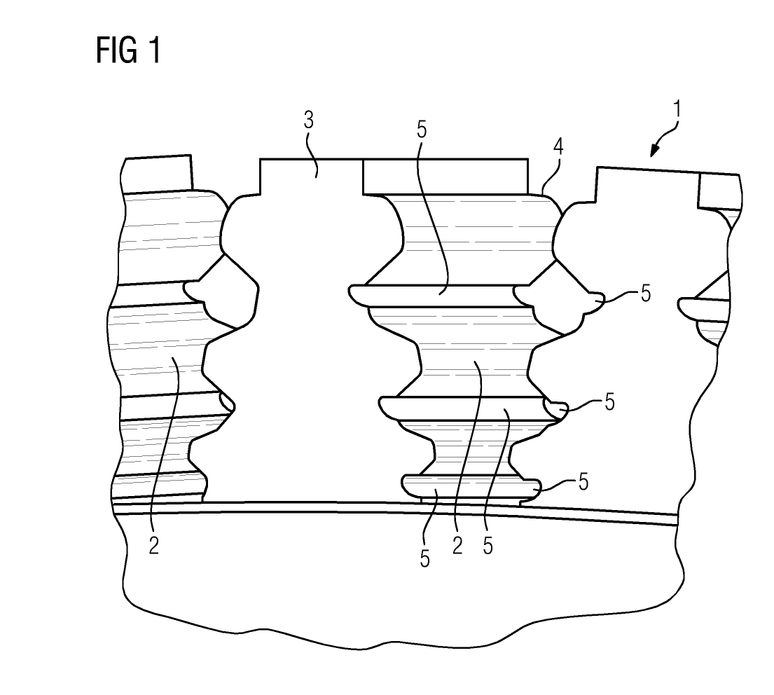

FIG. 1 shows a schematic partial view of a mechanically post-machined rotor disk of the rotor of a steam turbine, having pine-tree shaped receptacle grooves for fastening rotor blades;

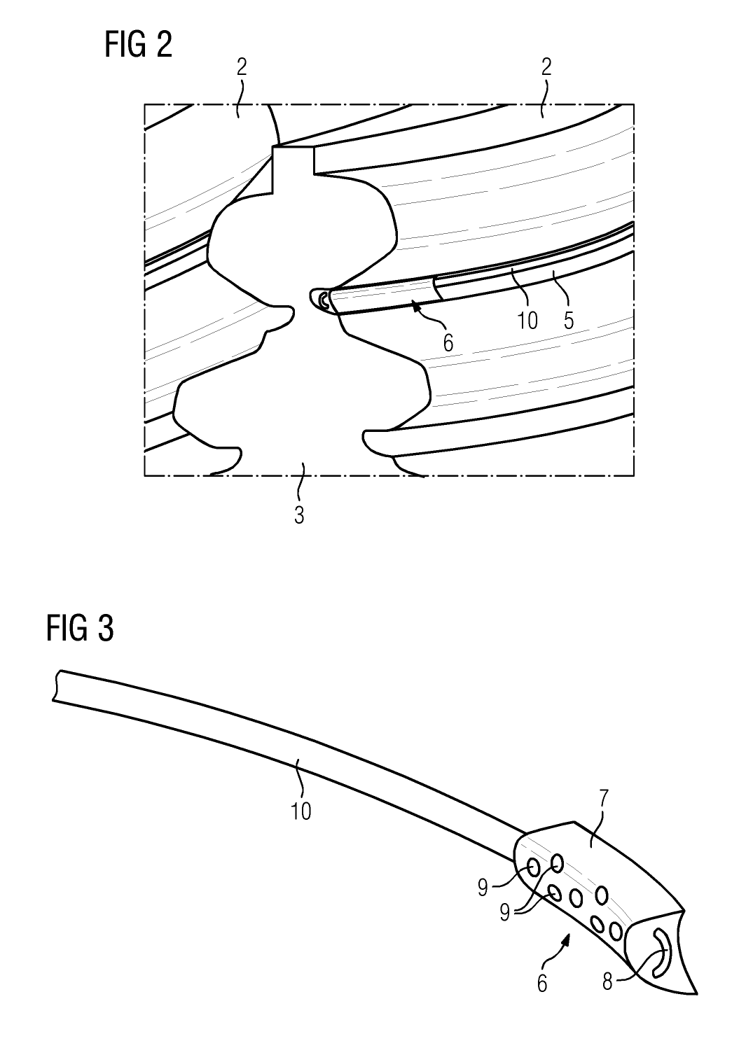

FIG. 2 shows a further schematic partial view of a mechanically post-machined rotor disk of the rotor of a steam turbine, having pine-tree shaped receptacle grooves and a testing head that is disposed in an intermediate space that has been created by the post-machining; and

FIG. 3 shows an enlarged view of the testing head of FIG. 2 in a schematic illustration.

Same reference signs hereunder refer to identical components, or components of equivalent configuration.

### DETAILED DESCRIPTION

FIG. 1 shows a partial view of a rotor disk 1 of a rotor of a steam turbine, said rotor not illustrated in more detail in FIG. 1. The rotor disk 1 is disposed on a shaft of the rotor, said shaft likewise not illustrated in FIG. 1.

A plurality of pine-tree shaped receptacle grooves 2 that are of equidistant spacing are provided along the circumference in the rotor disk 1 in order for rotor blades to be fastened. The receptacle grooves 2 in the axial direction of the rotor of the steam turbine extend through the rotor disk 1 across the entire axial extent of the latter, that is to say from the end side 3 of the rotor disk 1 that in FIG. 1 points toward the front, up to the end side 4 that in FIG. 1 points toward the rear. In the partial view according to FIG. 1, only two adjacent receptacle grooves 2 of the multiplicity of the receptacle grooves 2 in the rotor disk 1 can be seen. The receptacle grooves 2 are distinguished by a curved profile, the latter by virtue of the simplified illustration not being visible in FIG. 1, but being illustrated in FIG. 2 which shows a further schematic partial view of the rotor disk 1 of FIG. 1.

Pine-tree shaped blade roots of rotor blades can be push-fitted into the receptacle groove 2 in the axial direction. The blade roots have a shape that corresponds to that of the receptacle grooves 2, such that said blade roots in the assembled state sit in the receptacle grooves 2 in at least a substantially form-fitting manner, and said blade grooves by virtue of the pine-tree shaped contour are secured in the radial direction so as not to be released as the rotor rotates. For illustrative reasons, the rotor blades having the blade roots thereof are not shown in FIG. 1. If the rotor disk 1 is completely populated with rotor blades, that is to say if one blade root of a rotor blade sits in each receptacle groove 2, the rotor blades form one of a multiplicity of rotor blade rings of the rotor of the steam turbine.

The rotor disk 1 has already been in operation and in the context of a preceding revision has been checked in terms of the state thereof. To this end, the rotor blades were removed from the rotor disk 1 in that the blade roots of said rotor blades were pushed off the receptacle grooves 2 in the axial direction. Following the removal of the rotor blades, the surface of the rotor disk 1 in the region of the receptacle grooves 2 by means of a testing head of an eddy current testing apparatus was examined in a non-destructive manner for the presence of surface cracks. Surface cracks were detected herein in the region of the right receptacle groove 2 in FIG. 1, and the crack-containing regions of the rotor disk 1 in the region of this receptacle groove 2 were removed by milling. Specifically, the removal of crack-containing material in the case of the exemplary embodiment illustrated took place at a total of six locations, in each case across the entire axial extent of the rotor disk 1 in the region of the receptacle groove 2, by way of a defined cutting shape of a cross section of approximately semi-oval shape. As a result thereof, a total of six elongate post-machined grooves 5 were obtained, the latter lying in the region of the receptacle groove 2 and, as can be seen in FIG. 1, extending in the axial direction through the rotor disk 1 from the end side 3 of the rotor disk 1 that in FIG. 1 points toward the front, up to the end side 4 that in FIG. 1 points toward the rear. Each post-machined groove 5 is open where the original contour of the receptacle groove 2 used to run, wherein the open side in the assembled state, that is when a blade root sits in the receptacle groove 2, is closed by the blade root. The six post-machined grooves 5 in the right receptacle groove 2 are furthermore distinguished by a consistent cross section in the axial direction of the rotor disk 1, this likewise being derived from FIG. 1.

As a consequence of the mechanical post-machining by milling, a deviation between the shape of the component having the receptacle groove 2 and the shape of a blade root to be push-fitted into said receptacle groove 2 is present in the region of the post-machined contours, that is to say in the region of the six post-machined grooves 5. If a blade root is inserted into the receptacle groove 2, “gaps” are therefore present in the region of the preceding post-machining for the removal of cracks, said “gaps” in the case of the exemplary embodiment illustrated being defined by the respective post-machined groove 5 and in the assembled state, on the open side of the latter, by the blade root that sits in the receptacle groove.

The shape and the position of the post-machined grooves 5 can be particularly clearly identified by way of a comparison between the right and the left receptacle groove 2 in FIG. 1. No mechanical post-machining was required on the left receptacle groove 2, such that the original contour of the receptacle groove 2 is present here.

Once the rotor disk 1 upon the removal of the rotor blades had been checked, been post-machined in the region of the right receptacle groove 2 in order for cracks to be removed by milling, and the rotor blades been reinstalled, the components were in operation again over a predefined time. In order for the state of the rotor disk 1 in the region of the receptacle groove 2 to be rechecked, the method for non-destructive material testing according to embodiments of the present invention is subsequently carried out.

According to embodiments of the invention, in the case of the exemplary embodiment illustrated, the intermediate spaces which by virtue of the post-machining for the removal of cracks that has already been performed and which in the assembled state are defined by the six post-machined grooves 5 that have previously been incorporated in the rotor disk 1 by milling out the crack-containing material and are present between the rotor disk 1 and the blade root that is inserted into the receptacle groove 2, in the assembled state are utilized in a targeted manner in order for the testing head 6 of a testing apparatus to be disposed and displaced in said intermediate spaces. Specifically, an eddy current testing head 6 of an eddy current testing apparatus is incorporated in the post-machined grooves 5 in the assembled state, in order for the rotor disk 1 in the region of the respective post-machined groove 5 to be checked anew for the presence of faults, in particular surface cracks. The eddy current testing head that is inserted into a post-machined groove 5 is shown in FIG. 2. It is to be noted that the blade roots that sit in the receptacle grooves 3 are also not illustrated in FIG. 2. An enlarged schematic illustration of the eddy current testing head 6 can be derived from FIG. 3.

As can be seen in the figures, the eddy current testing head 6 has a main body 7 having a cross section which is adapted to the cross section of the post-machined grooves 5, such that the eddy current testing head 6 sits in a post-machined groove 5 in at least a substantially form-fitting manner when said eddy current testing head 6 has been incorporated in said post-machined groove 5 in the assembled state. In the case of the exemplary embodiment illustrated, the main body 7 is made from plastics.

As can be seen in FIGS. 2 and 3, a fastening element 8 for a position encoder, in particular for an encoder system, is provided on the eddy current testing head 6 on the end side of the main body 7 that in the figures faces toward the front. The fastening element 8 presently serves the purpose of enabling the free end of the steel cable of a steel cable encoder to be fastened to said fastening element 8. The steel cable encoder is not illustrated in FIG. 2.

The use of a position encoder makes it possible for the respective axial position coordinate to be assigned to the dynamically acquired measured values, such that a position-dependent set of measured data can be stored. The stored data by way of an analytical method can be evaluated in a positionally correct manner directly after measuring, for example. Image-providing methods (C-scan illustrations, for example) herein particularly benefit from a positionally correct representation of the measured data. Being diagnostic findings, the measured data stored that pertains in particular to detected cracks and includes the associated axial position can be resorted to for further subsequent mechanical measures, in particular for a mechanical removal of cracks.

As can be seen in FIG. 3, a total of seven testing elements 9, presently formed by coils, for eddy current testing are furthermore set in the side of the main body 7 that in FIG. 3 points toward the left. In the case of the exemplary embodiment illustrated, the surface of the rotor disk 1 in the region of the post-machined grooves 5 can thus be checked by the eddy current testing head 6.

Alternatively to the exemplary embodiment illustrated, testing elements 9 can be set in the side(s) of the main body 7 that point(s) toward the right, the top and/or the bottom, in order for the material, in particular also material of the blade root (not illustrated), to be checked in a non-destructive manner on all sides for surface cracks by the eddy current testing head 6.

On account of the main body 7 which in terms of the shape thereof is adapted to the shape of the post-machined grooves 5, the seven testing elements 9 are held in a predefined position when the testing head 6 is disposed in a post-machined groove 5 and is displaced therein, such that particularly reliable and comparable measured results can be obtained.

The eddy current testing head 6 which is identifiable in FIGS. 2 and 3 has been previously manufactured in a targeted manner, wherein the shape of the main body 7 has been chosen so as to depend on the shape of the existing intermediate spaces that are defined by the post-machined grooves 5.

Since all six post-machined grooves 5 in the case of the exemplary embodiment illustrated have the same cross section, the eddy current testing head 6 sits in an at least substantially form-fitting manner in all post-machined grooves 5.

If, alternatively to the exemplary embodiment described, post-machined grooves 5 of dissimilar shape are present, an expedient design embodiment eddy current testing heads 6 having main bodies 7 of correspondingly dissimilar shapes, are employed.

In order for the eddy current testing head 6 to be comfortably incorporated in the intermediate spaces that are defined by the post-machined grooves 5, and in order for the testing head to the comfortably displaced in the axial direction, the eddy current testing head 6 is connected to a guide bar 10. A user can comfortably grip the guide bar 10, introduce the testing head 6 into one of the post-machined grooves 5, displace said testing head 6 across the entire extent of said post-machined groove 5 in the axial direction, and can subsequently retrieve said testing head 6.

As can be seen in FIG. 2, the pine-tree shaped receptacle groove 2 is distinguished by a slight curvature. For reasons of simplification, this is not illustrated in FIG. 1. As can be likewise derived from FIG. 2, the post-machined grooves 5 are also distinguished by a curvature which corresponds to the curvature of the receptacle groove 2.

In order for the curvature to be comfortably followed, the guide bar 10 which is fastened to the eddy current testing head 6 in the case of the exemplary embodiment illustrated is configured so as to likewise be curved. The curvature corresponds to the curvature of the receptacle groove 2 and of the post-machined grooves 5.

As can be seen in FIG. 2, since the axial extent of the rotor disk 1 in the region of the receptacle groove 2, and thus the axial extent of the post-machined grooves 5, clearly exceed the axial extent of the testing head 6, for the non-destructive material test the testing head 6 with the aid of the guide bar 10 is displaced across the entire length of the post-machined grooves 5 in the axial direction in said post-machined grooves 5, and dynamic measuring is carried out.

As a result, renewed non-destructive material testing of the rotor disk 1 can be carried out in the region of the receptacle groove 2, specifically in the region of the post-machined grooves 5, in a particularly simple and comfortable manner. Since the method according to embodiments of the invention for non-destructive material testing can be performed in the assembled state, that is to say when the blade roots are inserted into the receptacle grooves 2 of the rotor disk 1, the complexity associated with the method is minor. Particularly efficient, cost-effective and reliable monitoring of the state of turbine components can be performed.

Since renewed non-destructive testing according to embodiments of the invention of the post-machined grooves 5 is possible at a comparatively minor complexity, a residual service life that has already been calculated can be dynamically adjusted and even prolonged by periodic testing. In particular, a previously calculated service life of a component having (a) receptacle groove(s), or of a blade root, respectively, can be checked according to embodiments of the invention by efficient measurements than can be readily carried out. For example, if a calculated service life is 3 years, and it is assumed that new cracks will arise with a high probability in a region of the component or of the blade root, respectively, that has already been mechanically post-machined in particular for the removal of cracks, this region which in particular can be the contour of a post-machined groove, can be checked anew in an efficient and simple manner by way of the method according to embodiments of the invention. In the case of no further indicators being registered, that is to say of now new cracks being detected, in the case of a subsequent check-up according to embodiments of the invention, the calculation can be reset to 0, for example, and the estimated service life is now valid for a further and potentially deviating interval.

Better planning and an optimized maintenance concept for a steam turbine becomes possible. In particular, repairs, the replacement of components, and order and delivery times can be optimized.

In the case of the exemplary embodiment illustrated, only one eddy current testing head 6 has been employed, said eddy current testing head 6 being sequentially incorporated in the six post-machined grooves and displaced along the latter in the axial direction in order for the state of the rotor disk 1 in the region of the post-machined contours to be checked. Of course, alternatively to the exemplary embodiments illustrated, it is possible for a plurality of testing heads to be employed; a plurality of testing heads can also be provided on one guide bar, in particular.

If a plurality of testing heads are employed in the context of the method according to embodiments of the invention, said testing heads can also be dissimilar testing heads, for example at least one eddy current testing head and at least one ultrasonic testing head, which can be incorporated conjointly or sequentially in an intermediate space.

In the case of the exemplary embodiment illustrated, an eddy current testing head has been employed specifically; alternatively, any other testing head by way of which non-destructive material testing is possible can be used. The ultrasonic testing method is to be mentioned in a purely exemplary manner. Said ultrasonic testing method can in particular be employed in order for a blade root that sits in the receptacle groove 2 to be checked in a non-destructive manner alternatively or additionally to the check-up of the rotor disk 1 in the region of the post-machined grooves 5 by means of an eddy current.

Alternatively or additionally to intermediate spaces being utilized according to the invention, as is the case in the exemplary embodiment described, said intermediate spaces having been present by virtue of a preceding removal of cracks, intermediate spaces which have been provided for this purpose in a targeted manner can also be utilized.

While the invention has been illustrated and described in more detail by way of the preferred exemplary embodiment, the invention is not limited by the examples disclosed, and other variations can be derived therefrom by a person skilled in the art without departing from the scope of the invention.

1. A method for the non-destructive material testing of a component that defines a receptacle groove for the blade root of a blade of an axial turbomachine, said component being a shaft of a turbine or of a compressor, or of a rotor disk that is provided on the shaft, and of a blade root of a blade, wherein the steps comprising:
disposing a testing head of a testing apparatus for non-destructive material testing in the assembled state in an intermediate space formed in the region of the receptacle groove between the component that defines the receptacle groove and the blade root, and is displaced in the intermediate space, and
disposing the component that defines the receptacle groove and/or the blade root by way of the testing head and
examining in the intermediate space in a non-destructive manner for material faults.

2. The method as claimed in claim 1, wherein the testing head is disposed and in particular displaced in an intermediate space which has been obtained by mechanical post-machining of the component that defines the receptacle groove and/or of the blade root, in that material faults which have preferably been detected in a preceding non-destructive material test are removed, from the component that defines the receptacle groove or from the blade root.

3. The method as claimed in claim 1, wherein the testing head is disposed and displaced in an intermediate space which is at least largely formed by a clearance that is provided in the component that defines the receptacle groove.

4. The method as claimed in claim 1, wherein the testing head is disposed and displaced in an intermediate space which is distinguished by a cross section that is consistent in the axial direction of the axial turbomachine.

5. The method as claimed in claim 1, wherein the testing head is disposed and in an intermediate space which in the axial direction of the axial turbomachine extends across the entire extent of the receptacle groove and/or of the root blade.

6. The method as claimed in claim 1, wherein the testing head is disposed and displaced in an intermediate space which in the assembled state is accessible from the outside, in particular from one end side or both end sides of the component that defines the receptacle groove, and/or of the blade root.

7. The method as claimed in claim 1, wherein the testing head is disposed in an elongate intermediate space and is disposed therein in the longitudinal direction, wherein the elongate intermediate space preferably extends in the axial direction of the axial turbomachine.

8. The method as claimed in claim 1, wherein the testing head of which the cross section is adapted to the cross section of the intermediate space is used.

9. The method as claimed in claim 1, wherein the testing head is disposed and displaced in an intermediate space which has a curvature, wherein the curvature corresponds in particular to a curvature of the receptacle groove.

10. The method as claimed in claim 1, wherein the testing head which is connected to a guide element, wherein the guide element is a guide bar.

11. The method as claimed in claim 9, wherein the testing head which is connected to a guide element, wherein the guide element is a guide bar having a curvature which is in particular adapted to the curvature of the intermediate space, is used.

12. The method as claimed in claim 1, wherein the testing head includes a plurality of testing heads which are disposed in the intermediate space, or are displaced therein, respectively.

13. The method as claimed in claim 11, wherein the plurality of testing heads are disposed on a guide element, wherein the guide element is a the guide bar.

14. The method as claimed in claim 1, wherein the testing head that is disposed in the intermediate space remains in the intermediate space for a predefined temporal period which includes an operating period of the axial turbomachine, and wherein the component that defines the receptacle groove and/or the blade root by way of the testing head that is disposed in the intermediate space are/is examined in a non-destructive manner for material faults during the operation of the axial turbomachine.

15. The method as claimed in claim 1, wherein the testing head is displaced in the intermediate space, and a position encoder is used in order for a position coordinate to be able to be assigned to the measured values in the case of a moving testing head.
